(19) United States
(12) Patent Application Publication
(10) Pub. No.: US 2024/0231093 A1
(43) Pub. Date: Jul. 11, 2024

(54) LIGHT FIELD DISPLAY ARCHITECTURE FOR HEADSET

(71) Applicant: Meta Platforms Technologies, LLC, Menlo Park, CA (US)

(72) Inventors: Robin Sharma, Woodinville, WA (US); Miaomiao Xu, Redmond, WA (US); Andrew Maimone, Duvall, WA (US); Scott Charles McEldowney, Redmond, WA (US)

(21) Appl. No.: 18/094,807

(22) Filed: Jan. 9, 2023

(51) Int. Cl. G02B 27/01; F21V 8/00

(52) U.S. Cl. CPC G02B 27/0172; G02B 6/0016; G02B 6/0036; G02B 6/005; G02B 2027/0174

(57) ABSTRACT

A light field display is composed of a light source assembly (LSA), a collimating lens, an incoupling section, a spatial light modulator (SLM), and gratings. The LSA includes point light sources that emit light at different time periods. The collimating lens collimates light from the point light sources. The incoupling section incouples the collimated light to a waveguide. The SLM spatially modulates the collimated light. The gratings outcouple spatially modulated light from the waveguide, and for any given point light source of the point light sources, the given point light source has a respective corresponding grating of the gratings that outcouples from the waveguide light that originated from the given point light source. The spatially modulated light output in each time period forms a respective virtual emitter in an eyebox, and over the different time periods the virtual emitters in aggregate form at least one virtual object.

### FIELD OF THE INVENTION

The present disclosure relates generally to a display, and specifically relates to a light field display architecture for a headset.

### BACKGROUND

Augmented reality headsets typically use combiners to overlay an image presented by the headset on top of visual content from the real world, which together form an augmented reality experience. But combiners for conventional light field based displays can be rather bulky—making them difficult to incorporate into small form factors (e.g., eyeglasses). Likewise, conventional combiners for light field displays can be very sensitive to eye relief, and are difficult to integrate see-though refractive error correction for the real world. Accordingly, conventional light field displays typically are not used in headsets having small form factors.

### SUMMARY

A light field (LF) display architecture for a headset is described. The LF display architecture may be integrated into headsets of different form factors. For example, it may be integrated into a headset with an eye glasses form factor, a headset with a head-mounted display form factor, etc. The LF display architecture describes a display assembly.

In some embodiments, a display assembly is described. The display assembly includes a light source assembly (LSA), a collimating lens, an incoupling section, a spatial light modulator (SLM), and a plurality of gratings. The LSA may include a plurality of point light sources that are configured to emit light at different time periods. The collimating lens is configured to collimate light from the plurality of point light sources. The incoupling section (e.g., incoupling prism, polarizing beam splitter) is configured to incouple the collimated light to a waveguide. The SLM is configured to spatially modulate the collimated light. The plurality of gratings is configured to outcouple spatially modulated light from the waveguide. For any given point light source of the plurality of point light sources, the given point light source may have a respective corresponding grating of the plurality of gratings that outcouples from the waveguide light that originated from the given point light source. The spatially modulated light output in each time period, of the different time periods, may form a respective virtual emitter in an eyebox of the display assembly, and over the different time periods the virtual emitters in aggregate form at least one virtual object.

In some embodiments, a headset is described. The headset includes a frame, a light source assembly (LSA), a collimating lens, an incoupling section, a spatial light modulator (SLM), and a plurality of gratings. The LSA is coupled to the frame, and may include a plurality of point light sources that are configured to emit light at different time periods. The collimating lens is configured to collimate light from the plurality of point light sources. The incoupling section (e.g., incoupling prism, polarizing beam splitter) is configured to incouple the collimated light to a waveguide. The SLM is configured to spatially modulate the collimated light. The plurality of gratings is configured to outcouple spatially modulated light from the waveguide. For any given point light source of the plurality of point light sources, the given point light source may have a respective corresponding grating of the plurality of gratings that outcouples from the waveguide light that originated from the given point light source. The spatially modulated light output in each time period, of the different time periods, may form a respective virtual emitter in an eyebox, and over the different time periods the virtual emitters in aggregate form at least one virtual object.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2A is a cross-sectional view of a display assembly including a holographic optical element, in accordance with one or more embodiments.

FIG. 2B is a front view of a portion of the display assembly of FIG. 2A.

FIG. 3 is a cross-sectional view of a display assembly including a holographic optical element and a beam splitter, in accordance with one or more embodiments.

FIG. 4 is a cross-sectional view of a display assembly including a holographic optical element and a light adjustment device, in accordance with one or more embodiments.

FIG. 5 is a cross-sectional view of a display assembly whose gratings directly outcouple light toward an eyebox, in accordance with one or more embodiments.

FIG. 6 is a block diagram of a system environment that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A light field (LF) display architecture for a headset is described. The LF display architecture may be integrated into headsets of different form factors (e.g., eyeglasses, head-mounted display). The LF display architecture describes a display assembly.

The display assembly is configured to present visual content to a wearer of the headset. The display assembly includes a light source assembly (LSA), a collimating lens, an incoupling section, a spatial light modulator (SLM), and a plurality of gratings. The LSA includes a plurality of point light sources (e.g., edge emitting lasers) that are configured to emit light at different time periods. The collimating lens is configured to collimate light from the plurality of point light sources. The incoupling section (e.g., incoupling prism, polarizing beam splitter) is configured to incouple the collimated light to a waveguide. The waveguide may be positioned such that it sits in front of the eyes of a wearer of the headset (e.g., as part of the lenses of a headset in an eye glass form factor). The SLM is configured to spatially modulate the collimated light. The plurality of gratings is configured to outcouple spatially modulated light from the waveguide. In some embodiments, for any given point light source of the plurality of point light sources, the given point light source may have a respective corresponding grating of the plurality of gratings that outcouples from the waveguide light that originated from the given point light source. In other embodiments, light from multiple point light sources are outcoupled via a same grating. In some embodiments the light for a given eye is directly outcoupled to a corresponding eyebox for that eye. The spatially modulated light output in each time period, of the different time periods, may form a respective virtual emitter in an eyebox (for a given eye) of the display assembly, and over the different time periods the virtual emitters in aggregate form at least one virtual object. In other embodiments, the outcoupled light is directed toward a holographic optical element (HOE). The HOE may be configured to receive spatially modulated light from different gratings of the plurality of gratings, and focus the light such that the focused light passes through the waveguide toward the eyebox to form the virtual emitters.

Note that portions of the display assembly may be integrated into a frame of the headset. For example, some or all of the LSA, some or all of the collimating lens, some or all of the incoupling section, some or all of the SLM, a portion of the waveguide, or some combination thereof, may be integrated into the frame. In this manner, the LF display architecture can incorporate many of its components into a frame, and thereby function as a combiner that may be easily integrated into small form factor headsets. Moreover, the described display assembly is not sensitive to eye-relief variability and is not sensitive to eyelashes because light is directed to the eye from the combiner directly and not from a projector located on the temple arm.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (or headset) connected to a host computer system, a standalone head-mounted display (or headset), a mobile device or computing system, or any other hardware platform capable of providing artificial reality content to one or more viewers.

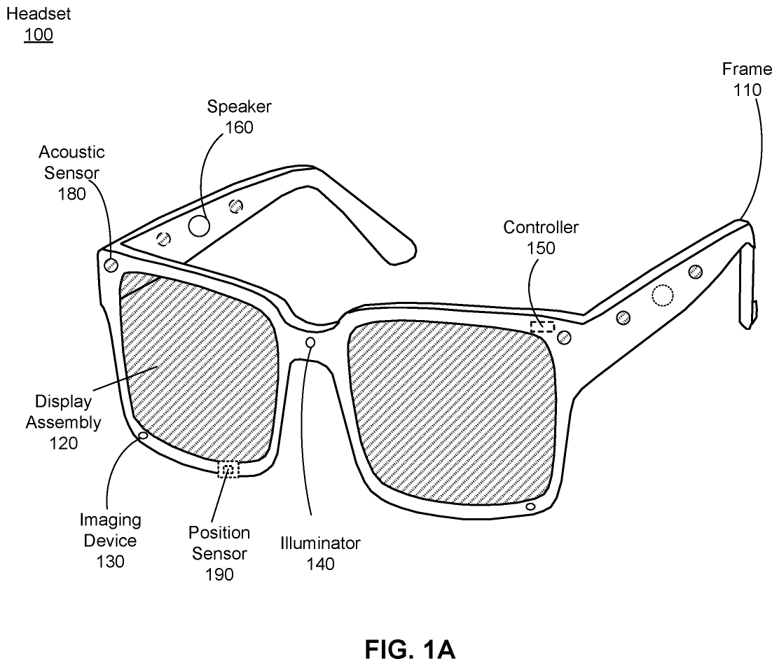

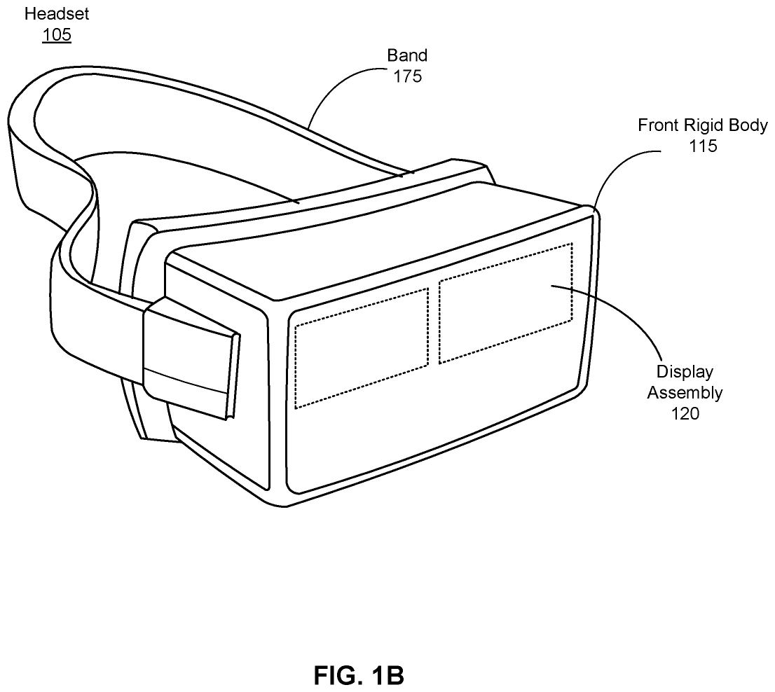

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display assemblies 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display assemblies 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

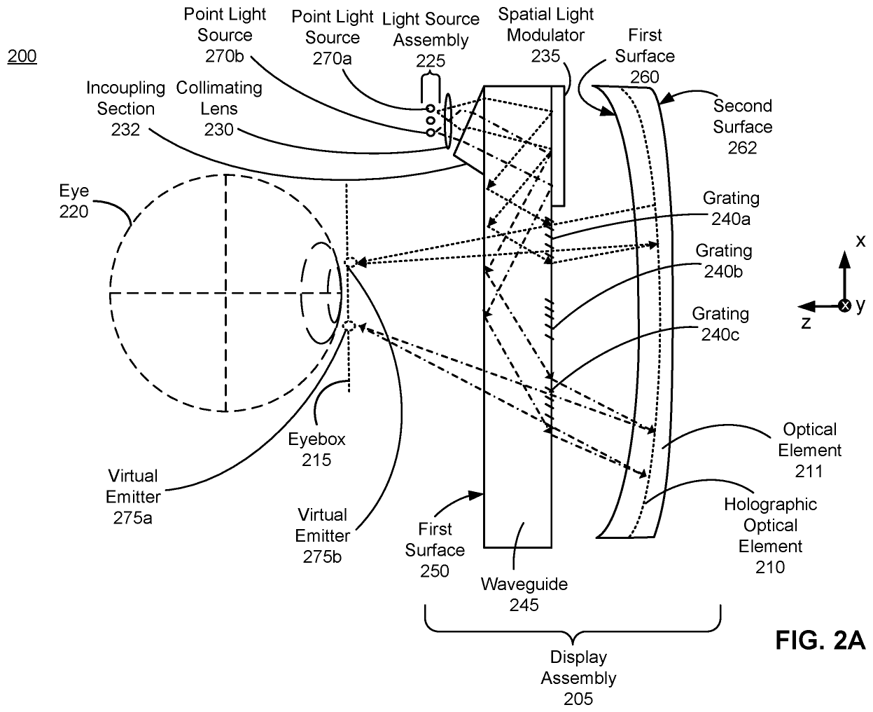

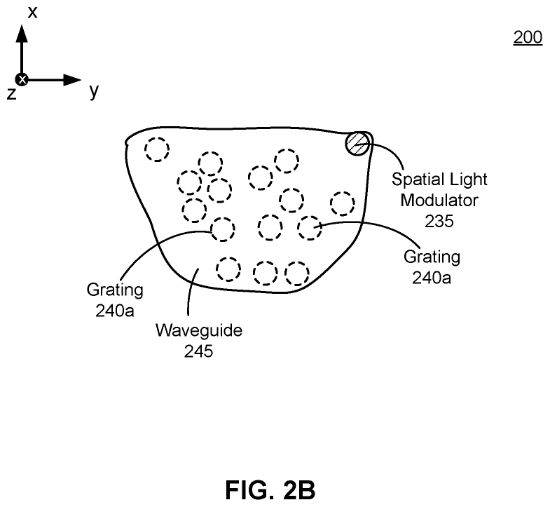

The one or more display assemblies 120 provide light to a user wearing the headset 100. As illustrated the headset includes a display assembly 120 for each eye of a user. Each display assembly 120 is a LF display. A display assembly 120 generates image light that is provided to an eyebox of the headset 100. The display assembly 120 for one or both eyes may generate the image light in accordance with instructions from a controller 150. The eyebox is a location in space that an eye of user occupies while wearing the headset 100. Each display assembly 120 functions as a LF display. Operation of the display assemblies are described in detail below with regard to FIGS. 2A-6.

Note that in some embodiments, one or both of the display assemblies 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display assemblies 120 are at least partially transparent, such that light from the local area may be combined with light from the one or more display elements to produce AR and/or MR content.

In some embodiments, the display assemblies 120 may include an additional optics block (not shown). The optics block may include one or more optical elements (e.g., lens, Fresnel lens, etc.) that direct light from a display assembly to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of speakers (e.g., the speaker 160). Although the speakers are shown exterior to the frame 110, the speakers may be enclosed in the frame 110. In some embodiments, instead of individual speakers for each ear, the headset 100 includes a speaker array comprising multiple speakers integrated into the frame 110 to improve directionality of presented audio content. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller processes information from the sensor array that describes sounds detected by the sensor array. The audio controller may comprise a processor and a computer-readable storage medium. The audio controller may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

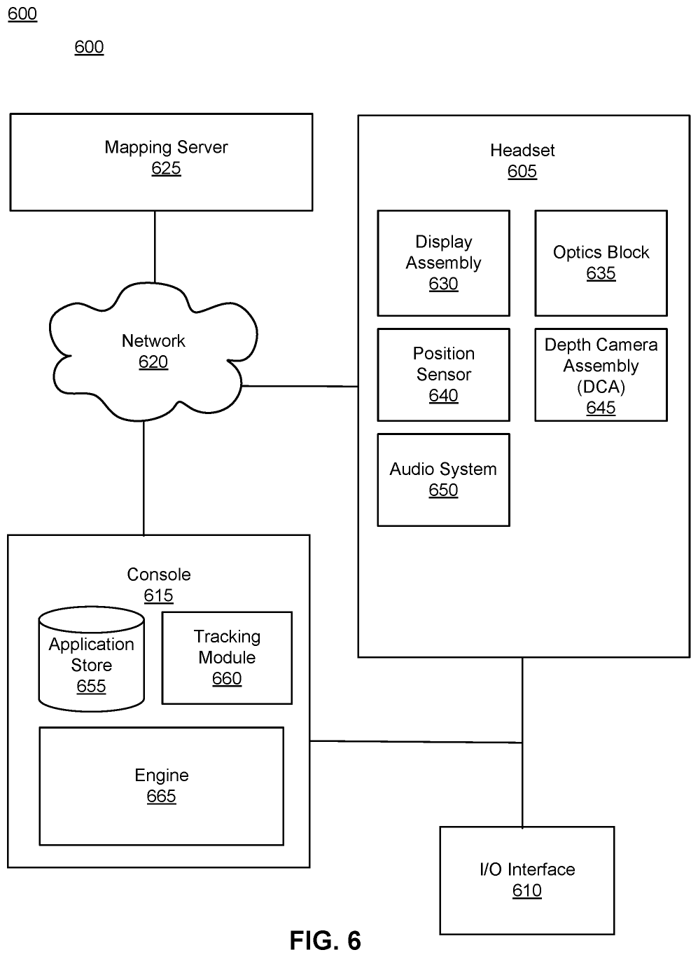

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 6.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes display assemblies (e.g., display assembly 120) described above with reference to FIG. 1A, but modified to integrate with the HMD form factor. For simplicity, only the display assemblies are illustrated, but the HMD may also include some of the components of the headset 100 (e.g., an illuminator, a plurality of the speakers, a plurality of the imaging devices, a plurality of acoustic sensors, a position sensor, and audio system, a DCA, etc.).

FIG. 2A is a cross-sectional view 200 of a display assembly 205 including a HOE 210, in accordance with one or more embodiments. In some embodiments, the display assembly 205 may be an embodiment of the display assembly 120. The cross-sectional view 200 shows components of the display assembly 205 that output light toward an eyebox 215 where an eye 220 would be positioned. The display assembly 205 may output the image light in accordance with instructions from a controller (e.g., the controller 150). As illustrated, the display assembly 205 includes a light source assembly 225, a collimating lens 230, an incoupling section 232, a spatial light modular (SLM) 235, a waveguide 245, a plurality of gratings, and the HOE 210. For purposes of illustration, FIG. 2A shows the view 200 associated with a single eye 220 and a single display assembly 205, but in alternative embodiments not shown, another display assembly that is separate from or integrated with the display assembly 205 shown in FIG. 2A, may provide image light to another eye of the user. Note FIG. 2A is a specific embodiment, and in other embodiments, the display assembly 205 may be modified to include features in later described figures and/or exclude one or more features shown in FIG. 2A.

The light source assembly 225 is configured to emit light. The light source assembly 225 includes a plurality of point light sources. A point light source may be, e.g., an edge emitting laser, a light emitting diode, a vertical cavity surface emitting laser (VCSEL), laser diode, some other light source, or some combination thereof. For simplicity, the light source assembly 225 as illustrated includes three point light sources in a single plane. In other embodiments, there may be more or less point sources in the plane and/or in other planes not shown. For example, the plurality of point light sources may form a 2D array of point light sources (e.g., 4λ4, 6×6, 10×10). In some embodiments, the plurality of point light sources emit light in the same color channel. In other embodiments, the plurality of point light sources may include at least some point light sources that emit in different color channels from one another (e.g., red, green, blue). The plurality of light sources are configured to emit light at different time periods (e.g., per instructions from the controller). In some embodiments, the light source assembly 225 may include a point light source and a 2D scanner.

The collimating lens 230 is configured to collimate light from the plurality of point light sources. As illustrated, a single optical element (e.g., positive lens) is used. But in other embodiments, the collimating lens 230 may include multiple optical elements. Note that the collimating lens 230 may be positioned at its focal distance from the plurality of light sources. In the case of a 2D scanner, the collimating lens may be located one focal length away from the point source. The 2D scanner may be located after the collimating lens. The collimating lens can be comprised of a plurality of lenses that can be manufactured through molding, diamond turning, 3D printing or casting. These lenses can also be a part of a wafer level optic assembly.

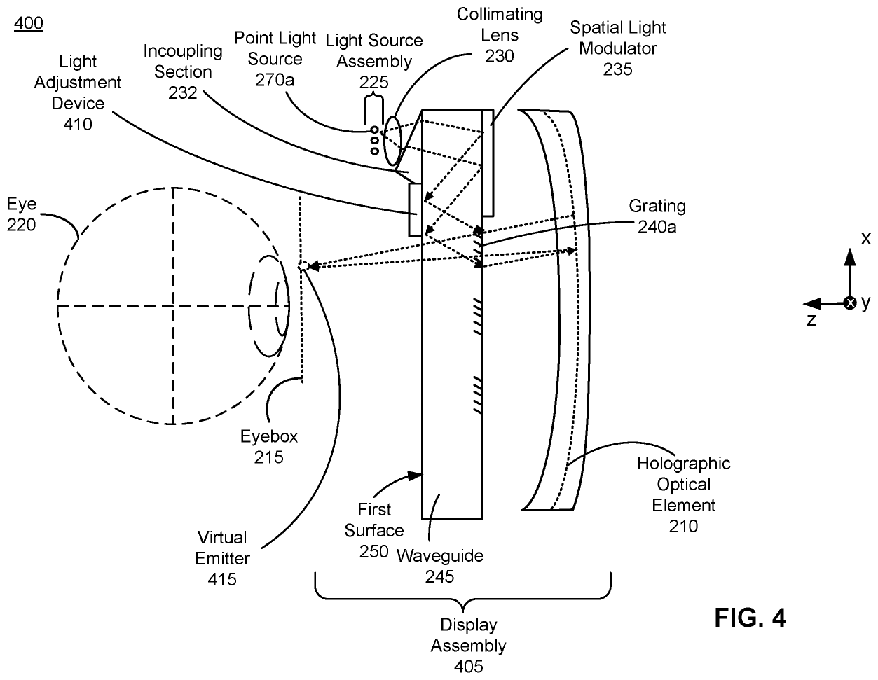

The incoupling section 232 is configured to incouple the collimated light from the collimating lens 230 into the waveguide 245. As shown in FIG. 2A, the incoupling section 232 is a prism that bends the collimated light enough such that total internal reflection can occur within the waveguide 245 (after interaction with the SLM 235). In other embodiments, the prism may be replaced by one or more gratings. An alternative embodiment of the incoupling section using a beam splitter is described below with regard to FIG. 4.

The SLM 235 is configured to spatially modulate the collimated light. As shown the collimated light has already been incoupled into the waveguide 245 via the incoupling section 232. The SLM 235 may be positioned a focal distance from the collimating lens 230. The SLM 235 includes a plurality of cells (not shown) that each are independently addressable and able to spatially modulate light different portions of the incoupled light (e.g., responsive to instructions from the controller). Each cell may be on the order of a micron squared in size. As illustrated, the SLM 235 is reflective (e.g., the SLM 235 may be, e.g., a liquid crystal on silicon spatial light modulator). In some embodiments, the SLM 235 may be sensitive to polarization (e.g., so either the light sources have to be polarized to begin with, or a polarizer will need to be included in the beam path before or after the collimating lens). In some embodiments, a front surface in contact with the waveguide 245 is a protective glass. The front surface may be laminated to a portion of the waveguide 245. The lamination process may use an index matching adhesive such that indices of refraction of the front surface, the adhesive, and the waveguide 245 are matched and/or substantially matched. The spatially modulated light reflects from the SLM 235 into the waveguide 245 where it undergoes total internal reflection.

The plurality of gratings are configured to outcouple the spatially modulated light from the waveguide 245. The plurality of gratings may be on a first surface 250 of the waveguide 245, a second surface 255 of the waveguide 245 (e.g., that is opposite the first surface 250) or some combination thereof. Note that in the illustrated cross section 200 includes three of the plurality of gratings (i.e., grating 240a, grating 240b, and grating 240c), but more generally, the plurality of gratings includes additional gratings that are distributed over different portions of the second surface 255 of the waveguide 245. In other embodiments, there may be gratings on the first surface 250 in combination with or in alternative to the second surface 255. The plurality of gratings generally form a 2D array of gratings (e.g., in a plane substantially parallel to the x-y plane). In some embodiments, for any given point light source of the plurality of point light sources, the given point light source has a respective corresponding grating of the plurality of gratings that outcouples from the waveguide 245 light that originated from the given point light source. In this manner a single grating outcouples light from a single point light source. In other embodiments, for a given point light source, there is a corresponding plurality of gratings that outcouples from the waveguide 245 light that originated from the given point light source. In some embodiments, the gratings are etched into the waveguide 245 (e.g., into the first surface 250 and/or the second surface 255). In some embodiments, the gratings are designed to extract light at a particular wavelength (e.g., red light, but not blue light). In some embodiments, the gratings are not designed for pupil replication. In some embodiments, some or all of the plurality of gratings cannot only extract light from the waveguide 245, but also expand the light by acting as diverging lenses. This may increase the numerical aperture of the display assembly, allowing for a larger field of view. Note that, as illustrated, the plurality of gratings outcouple the light from the waveguide 245 toward the HOE 210. In other embodiments (e.g., as described below in FIG. 6), the plurality of gratings outcouple the light from the waveguide 245 toward the eyebox 215.

The HOE 210 is configured to receive spatially modulated light outcoupled by the plurality of gratings, and focus the light, wherein the focused light passes through the waveguide 245 and forms one more virtual emitters in the eyebox 215. The HOE 2120 is a holographic optical element, nominally a photopolymer film that has been exposed to electric fields of light from one or more wavelengths to interferometrically record a grating like pattern within the film. These gratings respond to the light outcoupled by the slab waveguide by directing light towards the eye. As shown, the HOE 210 is immersed in an optical element 211. (e.g., plastic, glass, etc.) The optical element 211 has a first surface 260 and a second surface 262 that is opposite to the first surface 260. In other embodiments (not shown), the HOE 210 is a film that is applied to either the first surface 260 or the second surface 262 of the optical element 211.

The optical element 211 may be substantially transparent (e.g., in an AR and/or MR system) to visible light such that light from a local area may pass through the optical element, the HOE 210 and the waveguide 245 to reach the eyebox 215. The first surface 260 and the second surface 262 each have respective amounts of optical power. The optical power(s) may be negative, positive, or zero. For example, in some embodiments, the second surface 262 may have an optical power that is set to offset the optical power of the first surface 260 (e.g., to avoid distorting light from the local area). In some embodiments, the HOE 210 may be polarization dependent. For example, it may act on light of a particular polarization (s polarization, left circular polarization, etc.) while transmitting light in some other polarization (e.g., p polarization, right circular polarization, etc.). In some embodiments, the optical element 211 may have one or more films applied to one or both of the first surface 260 and the second surface 262. The one or more films may include, e.g., photochromic coatings, polarizers, anti-reflectors, etc. In some embodiments, the optical element 211 may also include one or more dimming elements.

Light from the plurality of point light sources are on at different time periods. Each point light source emits light that after propagation through the display assembly is output as a corresponding virtual emitter. In some embodiments, only point light sources that emit in a same band (e.g., red) are active for a given time period, then point light sources that emit in a different band (e.g., blue) are active for a subsequent time period, and so on. The corresponding virtual emitters that are created in the eyebox 215 are integrated by the eye 220 to create one or more virtual images. For example, as shown a point light source 270a emits light in a first band (e.g., red light) at a first time period. The light is collimated by the collimating lens 230 and incoupled into the waveguide via the incoupling section 232. The incoupled light is spatially modulated by the SLM 235 and reflected back into the waveguide 245. The spatially modulated light is then outcoupled via the grating 240a, which is configured to outcouple light from the point light source 270a toward the HOE 210. The HOE 210 focus the outcoupled light at the eyebox 215 as a virtual emitter 275a. Likewise in a subsequent time period, a point light source 270b emits light in a second band (e.g., green light). The light is collimated by the collimating lens 230 and incoupled into the waveguide via the incoupling section 232. The incoupled light is spatially modulated by the SLM 235 and reflected back into the waveguide 245. The spatially modulated light is then outcoupled via the grating 240a, which is configured to outcouple light from the point light source 270a toward the HOE 210. The HOE 210 focus the outcoupled light at the eyebox 215 as a virtual emitter 275b. In this manner, the display assembly 205 creates a plurality of virtual emitters in the eyebox 215 over one or more time periods that together the eye 220 aggregates into one or more virtual images. For viewing the real-world through the optical stack, the lens on the world side protects the waveguide and also corrects the refractive error for myopic, hyperopic or presbyopic individuals

FIG. 2B is a front view of a portion of the display assembly 205 of FIG. 2A. For simplicity, the front view is omitting the HOE 210. The front view shows the waveguide 245 from a x-y perspective. As described above light from the light source assembly 225 is incoupled into the waveguide 245 and is modulated by the SLM 235. The spatially modulated light undergoes total internal reflection within the waveguide 245 and ultimately outcoupled via at least one of the plurality of gratings. The waveguide 245 includes a plurality of gratings that are located in different positions along the waveguide 245. For simplicity, fifteen gratings are shown, but there may be more or less gratings and/or be positioned in different locations on the waveguide then illustrated in FIG. 2B. In some embodiments, each of the gratings only outcouple light from a single corresponding point light source. Continuing with the example described above with regard to FIG. 2A, light originating from the point light source 270a is output from the grating toward the HOE 210 (not shown).

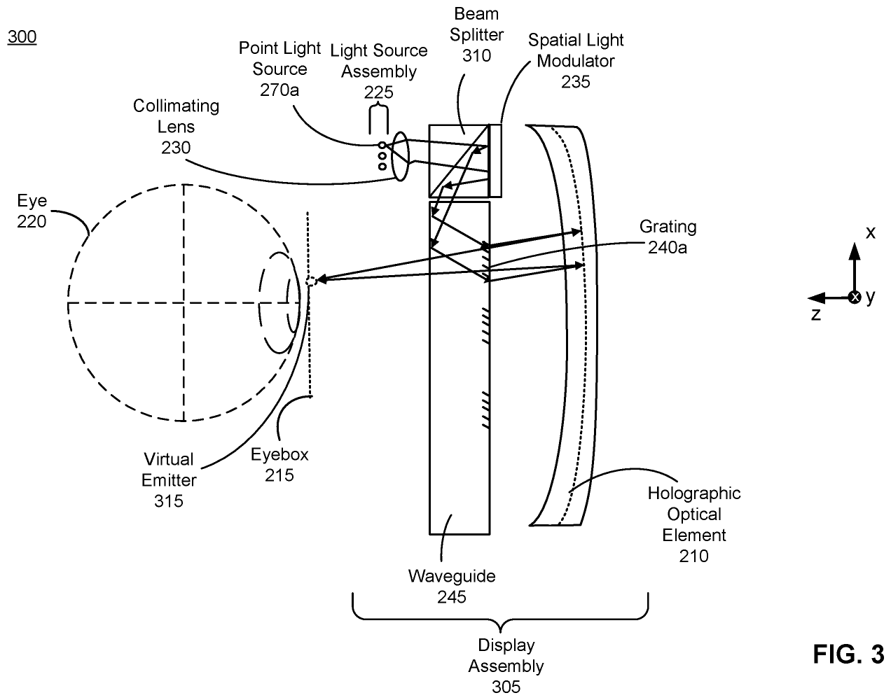

FIG. 3 is a cross-sectional view 300 of a display assembly 305 including the HOE 210 and a beam splitter 310, in accordance with one or more embodiments. The display assembly 305 is substantially the same to the display assembly 205 except that the incoupling section is the beam splitter 310 (v. a prism like in FIG. 2A). As illustrated there is a gap between the beam splitter 310 and the waveguide 245. In other embodiments, the beam splitter 310 may be directly coupled to the waveguide 245 and/or part of the waveguide 245. The beam splitter 310 may be, e.g., a polarizing beam splitter. The light from the light source assembly 225 may be polarized, and the beam splitter 310 may be configured to transmit light of a first polarization and reflect light of an orthogonal polarization. For example, light from the point light source 270 may be polarized (e.g., as emitted, via a polarizer, etc.). The light is collimated and is transmitted by the beam splitter 310. The light is spatially modulated via the SLM 235, which reflects the spatially modulated light back into the beam splitter 310. The reflection results in a change in polarization such that the spatially modulated light has a polarization that is orthogonal to the polarization of the light prior to the reflection. The beam splitter 310 reflects the light such that it incouples into the waveguide 245 at an angle where the light undergoes total internal reflection within the waveguide 245 until it outcouples via the grating 240a of the plurality of gratings, and ultimately forms a virtual emitter 315 in the eyebox 215.

FIG. 4 is a cross-sectional view 400 of a display assembly 405 including the HOE 210 and a light adjustment device 410, in accordance with one or more embodiments. The display assembly 405 is substantially the same to the display assembly 205 except that it also includes the light adjustment device 410. The light adjustment device 410 is coupled to the first surface 250 of the waveguide 245. Note that the SLM 235 may spatially modulate amplitude of the incoupled light. The light adjustment device 410 is configured to adjust the spatially modulated light from the SLM 235. In some embodiments, the light adjustment device 410 is a phase SLM. The phase SLM may be configured to modulate phase of the spatially modulated light. Accordingly, the SLM 235 and the phase SLM together can modulate amplitude and phase of the incoupled light. This can allow for better control of aberrations and image quality through the display.

In some embodiments, the light adjustment device may include one or more switchable gratings. The switchable gratings may be used to help steer the light within the waveguide 245. For example, the switchable gratings may selectively activate in accordance with instructions from the controller to direct light from the SLM 235 to a specific grating of the plurality of gratings.

For example, as shown the point light source 270a emits light in a first band (e.g., red light) at a first time period. The light is collimated by the collimating lens 230 and incoupled into the waveguide 245 via the incoupling section 232. The incoupled light is spatially modulated by the SLM 235 and reflected back into the waveguide 245. The spatially modulated light is adjusted via the light adjustment device 410, and outcoupled via the grating 240a (which is configured to outcouple light from the point light source 270a toward the HOE 210). The HOE 210 focuses the outcoupled light at the eyebox 215 as a virtual emitter 415.

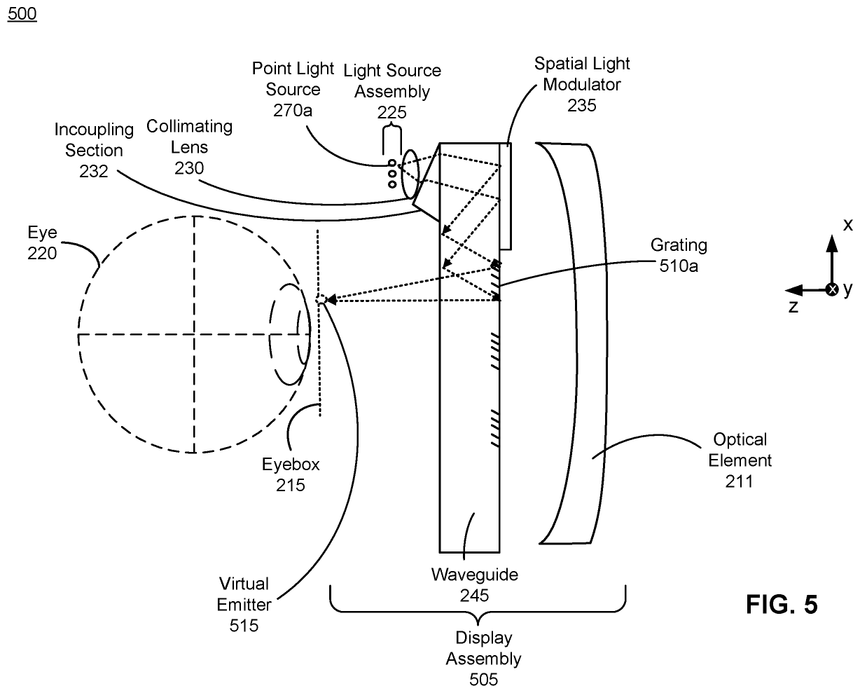

FIG. 5 is a cross-sectional view 500 of a display assembly 505 whose gratings directly outcouple light toward the eyebox, in accordance with one or more embodiments. The display assembly 505 is substantially the same to the display assembly 205 except that does not include a HOE (e.g., the HOE 210), and the plurality of gratings outcouple light from the waveguide 245 toward the eyebox 215 where the outcoupled light forms one or more virtual emitters (e.g., the virtual emitter 515). Note as shown in FIG. 5, the display assembly 505 includes the optical element 211. The optical element 211 may be used to, e.g., correct vision of the user, protect the waveguide 245 from damage (e.g., accidental drop), or some combination thereof. In other embodiments (not shown), the display assembly 505 does not include the optical element 211.

For example, as shown the point light source 270a emits light in a first band (e.g., red light) at a first time period. The light is collimated by the collimating lens 230 and incoupled into the waveguide 245 via the incoupling section 232. The incoupled light is spatially modulated by the SLM 235 and reflected back into the waveguide 245. The spatially modulated light is outcoupled from the waveguide 245 via a grating 510a of the plurality of gratings coupled to the waveguide 245. The plurality of gratings are configured to outcouple light from the waveguide 245 toward the eyebox 215 to form one or more virtual emitters. As shown, the grating 510a is configured to outcouple light from the point light source 270a toward the eyebox 215. The grating 510 is configured to focus the outcoupled light at the eyebox 215 as a virtual emitter 515.

### System Environment

FIG. 6 is a system 600 that includes a headset 605, in accordance with one or more embodiments. In some embodiments, the headset 605 may be the headset 100 of FIG. 1A or the headset 105 of FIG. 1B. The system 600 may operate in an artificial reality environment (e.g., a virtual reality environment, an augmented reality environment, a mixed reality environment, or some combination thereof). The system 600 shown by FIG. 6 includes the headset 605, an input/output (I/O) interface 610 that is coupled to a console 615, the network 620, and the mapping server 625. While FIG. 6 shows an example system 600 including one headset 605 and one I/O interface 610, in other embodiments any number of these components may be included in the system 600. For example, there may be multiple headsets each having an associated I/O interface 610, with each headset and I/O interface 610 communicating with the console 615. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments. For example, some or all of the functionality of the console 615 may be provided by the headset 605.

The headset 605 includes one or more display assemblies 630, optionally includes an optics block 635, one or more position sensors 640, and the DCA 645. Some embodiments of headset 605 have different components than those described in conjunction with FIG. 6. Additionally, the functionality provided by various components described in conjunction with FIG. 6 may be differently distributed among the components of the headset 605 in other embodiments, or be captured in separate assemblies remote from the headset 605.

The display assembly 630 displays content to the user in accordance with data received from the console 615. The display assembly 630 displays the content. In some embodiments, the headset 605 may include a single display assembly 630 (e.g., for a single eye, for both eyes). In some embodiments, there is a display assembly 630 for each eye. Note in embodiments that include the optics block 635, the display assembly 630 may also include some or all of the functionality of the optics block 635. The display assembly 630 may be an embodiment of and/or combination of any of the display assemblies discussed above with reference to FIGS. 1A-5.

The optics block 635 may magnify image light received from the electronic display, corrects optical errors associated with the image light, and presents the corrected image light to one or both eyeboxes of the headset 605. In various embodiments, the optics block 635 includes one or more optical elements. Example optical elements included in the optics block 635 include: an aperture, a Fresnel lens, a convex lens, a concave lens, a filter, a reflecting surface, or any other suitable optical element that affects image light. Moreover, the optics block 635 may include combinations of different optical elements. In some embodiments, one or more of the optical elements in the optics block 635 may have one or more coatings, such as partially reflective or anti-reflective coatings.

Magnification and focusing of the image light by the optics block 635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 635 corrects the distortion when it receives image light from the electronic display generated based on the content.

The position sensor 640 is an electronic device that generates data indicating a position of the headset 605. The position sensor 640 generates one or more measurement signals in response to motion of the headset 605. The position sensor 190 is an embodiment of the position sensor 640. Examples of a position sensor 640 include: one or more IMUs, one or more accelerometers, one or more gyroscopes, one or more magnetometers, another suitable type of sensor that detects motion, or some combination thereof. The position sensor 640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 605 from the sampled data. For example, the IMU integrates the measurement signals received from the accelerometers over time to estimate a velocity vector and integrates the velocity vector over time to determine an estimated position of a reference point on the headset 605. The reference point is a point that may be used to describe the position of the headset 605. While the reference point may generally be defined as a point in space, however, in practice the reference point is defined as a point within the headset 605.

The DCA 645 generates depth information for a portion of the local area. The DCA includes one or more imaging devices and a DCA controller. The DCA 645 may also include an illuminator. Operation and structure of the DCA 645 is described above with regard to FIG. 1A.

The audio system 650 provides audio content to a user of the headset 605. The audio system 650 is substantially the same as the audio system describe above with regard to FIG. 1A. The audio system 650 may comprise one or acoustic sensors, one or more transducers, and an audio controller. The audio system 650 may provide spatialized audio content to the user. In some embodiments, the audio system 650 may request acoustic parameters from the mapping server 625 over the network 620. The acoustic parameters describe one or more acoustic properties (e.g., room impulse response, a reverberation time, a reverberation level, etc.) of the local area. The audio system 650 may provide information describing at least a portion of the local area from e.g., the DCA 645 and/or location information for the headset 605 from the position sensor 640. The audio system 650 may generate one or more sound filters using one or more of the acoustic parameters received from the mapping server 625, and use the sound filters to provide audio content to the user.

The I/O interface 610 is a device that allows a user to send action requests and receive responses from the console 615. An action request is a request to perform a particular action. For example, an action request may be an instruction to start or end capture of image or video data, or an instruction to perform a particular action within an application. The I/O interface 610 may include one or more input devices. Example input devices include: a keyboard, a mouse, a game controller, or any other suitable device for receiving action requests and communicating the action requests to the console 615. An action request received by the I/O interface 610 is communicated to the console 615, which performs an action corresponding to the action request. In some embodiments, the I/O interface 610 includes an IMU that captures calibration data indicating an estimated position of the I/O interface 610 relative to an initial position of the I/O interface 610. In some embodiments, the I/O interface 610 may provide haptic feedback to the user in accordance with instructions received from the console 615. For example, haptic feedback is provided when an action request is received, or the console 615 communicates instructions to the I/O interface 610 causing the I/O interface 610 to generate haptic feedback when the console 615 performs an action.

The console 615 provides content to the headset 605 for processing in accordance with information received from one or more of: the DCA 645, the headset 605, and the I/O interface 610. In the example shown in FIG. 6, the console 615 includes an application store 655, a tracking module 660, and an engine 665. Some embodiments of the console 615 have different modules or components than those described in conjunction with FIG. 6. Similarly, the functions further described below may be distributed among components of the console 615 in a different manner than described in conjunction with FIG. 6. In some embodiments, the functionality discussed herein with respect to the console 615 may be implemented in the headset 605, or a remote system.

The application store 655 stores one or more applications for execution by the console 615. An application is a group of instructions, that when executed by a processor, generates content for presentation to the user. Content generated by an application may be in response to inputs received from the user via movement of the headset 605 or the I/O interface 610. Examples of applications include: gaming applications, conferencing applications, video playback applications, or other suitable applications.

The tracking module 660 tracks movements of the headset 605 or of the I/O interface 610 using information from the DCA 645, the one or more position sensors 640, or some combination thereof. For example, the tracking module 660 determines a position of a reference point of the headset 605 in a mapping of a local area based on information from the headset 605. The tracking module 660 may also determine positions of an object or virtual object. Additionally, in some embodiments, the tracking module 660 may use portions of data indicating a position of the headset 605 from the position sensor 640 as well as representations of the local area from the DCA 645 to predict a future location of the headset 605. The tracking module 660 provides the estimated or predicted future position of the headset 605 or the I/O interface 610 to the engine 665.

The engine 665 executes applications and receives position information, acceleration information, velocity information, predicted future positions, or some combination thereof, of the headset 605 from the tracking module 660. Based on the received information, the engine 665 determines content to provide to the headset 605 for presentation to the user. For example, if the received information indicates that the user has looked to the left, the engine 665 generates content for the headset 605 that mirrors the user's movement in a virtual local area or in a local area augmenting the local area with additional content. Additionally, the engine 665 performs an action within an application executing on the console 615 in response to an action request received from the I/O interface 610 and provides feedback to the user that the action was performed. The provided feedback may be visual or audible feedback via the headset 605 or haptic feedback via the I/O interface 610.

The network 620 couples the headset 605 and/or the console 615 to the mapping server 625. The network 620 may include any combination of local area and/or wide area networks using both wireless and/or wired communication systems. For example, the network 620 may include the Internet, as well as mobile telephone networks. In one embodiment, the network 620 uses standard communications technologies and/or protocols. Hence, the network 620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 620 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 625 may include a database that stores a virtual model describing a plurality of spaces, wherein one location in the virtual model corresponds to a current configuration of a local area of the headset 605. The mapping server 625 receives, from the headset 605 via the network 620, information describing at least a portion of the local area and/or location information for the local area. The user may adjust privacy settings to allow or prevent the headset 605 from transmitting information to the mapping server 625. The mapping server 625 determines, based on the received information and/or location information, a location in the virtual model that is associated with the local area of the headset 605. The mapping server 625 determines (e.g., retrieves) one or more acoustic parameters associated with the local area, based in part on the determined location in the virtual model and any acoustic parameters associated with the determined location. The mapping server 625 may transmit the location of the local area and any values of acoustic parameters associated with the local area to the headset 605.

One or more components of system 600 may contain a privacy module that stores one or more privacy settings for user data elements. The user data elements describe the user or the headset 605. For example, the user data elements may describe a physical characteristic of the user, an action performed by the user, a location of the user of the headset 605, a location of the headset 605, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A display assembly comprising:
a light source assembly including a plurality of point light sources that are configured to emit light at different time periods;
a collimating lens configured to collimate light from the plurality of point light sources;
an incoupling section configured to incouple the collimated light to a waveguide;
a spatial light modulator (SLM), the SLM configured to spatially modulate the collimated light; and
a plurality of gratings configured to outcouple spatially modulated light from the waveguide, wherein for any given point light source of the plurality of point light sources, the given point light source has a respective corresponding grating of the plurality of gratings that outcouples from the waveguide light that originated from the given point light source,
wherein spatially modulated light output in each time period, of the different time periods, forms a respective virtual emitter in an eyebox of the display assembly, and over the different time periods the virtual emitters in aggregate form at least one virtual object.

2. The display assembly of claim 1, comprising:
a holographic optical element (HOE) configured to receive spatially modulated light from different gratings of the plurality of gratings, and focus the light, wherein the focused light passes through the waveguide and forms the virtual emitters.

3. The display assembly of claim 2, wherein the HOE is immersed in an optical element.

4. The display assembly of claim 2, wherein the HOE is a film applied to an optical element.

5. The display assembly of claim 1, comprising:
a holographic optical element configured to receive spatially modulated light from different gratings of the plurality of gratings, and diverge the spatially modulated light.

6. The display assembly of claim 1, wherein the incoupling section includes:
an incoupling prism that is configured to bend light received from the collimating lens in order to incouple it to the waveguide,
wherein the incoupling prism is coupled to a first surface of the waveguide and the SLM is coupled to a second surface of the waveguide and the incoupling prism and the SLM are positioned substantially opposite each other on opposite sides of the waveguide.

7. The display assembly of claim 1, wherein the incoupling section includes:
a beam splitter that is configured to transmit light received from the collimating lens to the SLM, and incouple spatially modulated light from the SLM into the waveguide.

8. The display assembly of claim 1, wherein the SLM modulates amplitude, the display assembly further comprising:
a phase SLM configured to modulate phase of the spatially modulated light, wherein the phase SLM is coupled to a first surface of the waveguide and the SLM is coupled to a second surface of the SLM, wherein the first surface is opposite that of the second surface.

9. The display assembly of claim 1, further comprising:
a switchable grating assembly that is coupled to a first surface of the waveguide and the plurality of gratings is coupled to a second surface of the SLM, wherein the first surface is opposite that of the second surface, the switchable grating assembly including at least one switchable grating configured to steer the spatially modulated light within the waveguide.

10. The display assembly of claim 1, wherein the display assembly is integrated into a headset.

11. A headset comprising:
a frame;
a light source assembly coupled to the frame, the light source assembly including a plurality of point light sources that are configured to emit light at different time periods;
a collimating lens configured to collimate light from the plurality of point light sources;
an incoupling section configured to incouple the collimated light to a waveguide;
a spatial light modulator (SLM), the SLM configured to spatially modulate the collimated light; and
a plurality of gratings configured to outcouple spatially modulated light from the waveguide, wherein for any given point light source of the plurality of point light sources, the given point light source has a respective corresponding grating of the plurality of gratings that outcouples from the waveguide light that originated from the given point light source,
wherein spatially modulated light output in each time period, of the different time periods, forms a respective virtual emitter in an eyebox, and over the different time periods the virtual emitters in aggregate form at least one virtual object.

12. The headset of claim 11, comprising:
a holographic optical element (HOE) configured to receive spatially modulated light from different gratings of the plurality of gratings, and focus the light, wherein the focused light passes through the waveguide and forms the virtual emitters.

13. The headset of claim 12, wherein the HOE is immersed in an optical element.

14. The headset of claim 12, wherein the HOE is a film applied to an optical element.

15. The headset of claim 11, comprising:
a holographic optical element configured to receive spatially modulated light from different gratings of the plurality of gratings, and diverge the spatially modulated light.

16. The headset of claim 11, wherein the incoupling section includes:
an incoupling prism that is configured to bend light received from the collimating lens in order to incouple it to the waveguide,
wherein the incoupling prism is coupled to a first surface of the waveguide and the SLM is coupled to a second surface of the waveguide and the incoupling prism and the SLM are positioned substantially opposite each other on opposite sides of the waveguide.

17. The headset of claim 11, wherein the incoupling section includes:
a beam splitter that is configured to transmit light received from the collimating lens to the SLM, and incouple spatially modulated light from the SLM into the waveguide.

18. The headset of claim 11, wherein the SLM modulates amplitude, the headset further comprising:
a phase SLM configured to modulate phase of the spatially modulated light, wherein the phase SLM is coupled to a first surface of the waveguide and the SLM is coupled to a second surface of the SLM, wherein the first surface is opposite that of the second surface.

19. The headset of claim 11, further comprising:
a switchable grating assembly that is coupled to a first surface of the waveguide and the plurality of gratings is coupled to a second surface of the SLM, wherein the first surface is opposite that of the second surface, the switchable grating assembly including at least one switchable grating configured to steer the spatially modulated light within the waveguide.

20. The headset of claim 11, wherein the waveguide is positioned such that while the headset is worn at least a portion of the waveguide is located in front of an eye of a wearer of the headset.
